(19) United States
(12) Patent Application Publication
(10) Pub. No.: US 2009/0008332 A1
(43) Pub. Date: Jan. 8, 2009

(54) NANOFILTRATION WATER-SOFTENING APPARATUS AND METHOD

(76) Inventors: Robert Sung Lee, Minnetonka, MN (US); Harapanahalli S. Muralidhara, Plymouth, MN (US); Martin N. Aschauer, Port Huron, MI (US)

Correspondence Address: PERKINS COIE LLP, POST OFFICE BOX 1208, SEATTLE, WA, 98111-1208, US

(21) Appl. No.: 12/044,822

(22) Filed: Mar. 7, 2008

Related U.S. Application Data
(63) Continuation of application No. 09/909,488, filed on Jul. 20, 2001, now abandoned.

(51) Int. Cl. B01D 61/02; B01D 61/12; C02F 1/44

(52) U.S. Cl. 210/651

(57) ABSTRACT

An apparatus and methods for softening water is disclosed. In particular, an apparatus and method for softening water without the addition of ions the wastewater stream is disclosed. The apparatus generally includes at least one nanofiltration filter element configured and arranged to receive an input flow of hard water, discharge an output flow of permeate water comprising a portion of the input flow, and discharge an output flow of non-permeate water comprising a portion of the input flow. The nanofiltration filter element typically has an average pore size that permits the passage of water and monovalent ions but substantially prevents the passage of divalent ions.

### CROSS-REFERENCE TO RELATED APPLICATION

The present application is a continuation of U.S. patent application Ser. No. 09/909,488 filed Jul. 20, 2001, the disclosure of which is incorporated herein by reference as if fully set forth herein.

### FIELD OF THE INVENTION

The present invention is directed to apparatuses and methods for treating water. In particular, the invention is directed to apparatuses and methods for softening potable water used in modest sized water supply systems.

### BACKGROUND

Water containing high levels of calcium and magnesium ions is called “hard water” because these two ions can combine with other ions and compounds to form a hard, unattractive scale. Millions of homes have hard water supplies, particularly homes that use groundwater as their water source. Private residential wells are a major source of hard water, as are municipal water supplies that rely on groundwater sources. Hard water can result in formation of an unattractive film around sinks and dishes, and hard water deposits can form on clothing resulting in discoloration and reduced fabric softness. Also, some soaps and detergents do not work as well with hard water. In such situations, uncomfortable or unsightly soap films can be left behind on the person or object being washed.

Water softening devices (“water softeners”) have been developed to reduce hard water by removing the “hardness” ions. Most household water softeners utilize ion exchange technology that preferentially removes hardness ions and replaces them with sodium, a “soft” ion. Such softener systems typically include a resin material, a brine tank to provide a source of sodium for regenerating the resin, and hydraulic controls to direct the flow of water through the softener during service and regeneration. At the beginning of the softening cycle sodium ions occupy the resin's exchange sites. As water passes through it, the resin's stronger attraction for the hardness ions cause the resin to take on the hardness ions and give up its sodium ions. Iron, calcium, and magnesium are considered hardness ions and they are generally removed, provided they are in solution. However, ion exchange generally does not remove suspended matter.

An estimated one million water softeners are sold each year in the United States alone, and hundreds of millions of dollars is spent on salt. Approximately 7 to 12 percent of all private homes have water softeners. The rate of water softener use is higher in rural areas than in cities, with an estimated 3 percent of urban dwellers using a water softener. The majority of these softeners are installed in homes and small businesses that acquire their water supplies from groundwater.

Although ion exchange softeners are suitable for many applications, they have significant limitations. In particular, ion exchange water-softening results in a net increase in the salinity of discharged water because of the brine discharge. This net increase in discharge salinity can be problematic in areas where anti-brine discharge regulations are in place. These regulations often exist in localities that reuse discharged water for agricultural purposes and which wish to avoid adding excess salt to land on which the discharged water is applied. In addition, ion exchange filters require regular replacement of the sodium salts for recharging the resin, and maintenance costs associated with the purchase of the salt.

In view of the significant problems associated with hard water, as well as the limitations of existing water softeners, a need exists for an improved water-softening system.

### SUMMARY OF THE INVENTION

The present invention is directed to apparatuses and methods for softening water, in particular to apparatuses and methods for softening water without the addition of ions to the wastewater stream. The apparatuses use at least one nanofiltration filter element to selectively remove hardness ions, in particular large ions (such as the divalent ions of calcium and magnesium), in order to soften the water without adding salt to the wastewater stream.

Water softeners made in accordance with the invention generally include at least one nanofiltration filter element configured to have an input flow of water and two discharge flows. The input flow receives potable hard water, which is divided into a first output flow of permeate water comprising a portion of the input flow, and a second output flow of non-permeate water comprising the remainder of the input flow. At least a portion of the output flow of permeate water has a lower hardness than the output flow of non-permeate water.

The nanofiltration filter element typically has an average pore size that permits the passage of water and most monovalent ions but substantially prevents the passage of most divalent ions. The apparatus is advantageously constructed such that it does not increase the total salt levels relative to the input flow of water. Thus, the softening apparatus does not add ions to the water stream, but rather removes at least some of the ions from the input flow and discharges them into the discarded non-permeate output flow. Various different nanofiltration filter elements are suitable for use with the invention, including filter elements that contain a positively charged membrane.

The present invention is suitable for production of softened water from relatively low pressure at sufficiently high flow rates to satisfy typical residential water needs. Water softeners made in accordance with the invention can produce suitable sustainable flow at a pressure of less than 200 pounds per square inch. Specific embodiments of the invention provide an apparatus configured and arranged to have an output flow of permeate water of 200 gallons or more per 24-hour period. The softening apparatus is also generally highly efficient, and able to produce an output flow of permeate water containing greater than 80 percent of the input flow. In certain embodiments the output flow of permeate water contains greater than 85 percent of the input flow, while in yet other embodiments the output flow of permeate water contains greater than 90 percent of the input flow. The output flow of permeate water generally can have, for example, a hardness below 3.5 grains per gallon. The present invention is well suited for use with potable water, and thus the input flow normally comprises potable water, such as that available from municipal water supplies or out of residential wells.

The present invention is also directed to methods of softening water. The methods generally include providing at least one nanofiltration filter element configured and arranged to receive an input flow of hard water; discharge a first output flow of permeate water comprising a portion of the input flow and which has passed through the nanofiltration filter; and discharge a second output flow of non-permeate water comprising a portion of the input flow and which has not passed through the nanofiltration filter. The output flow of permeate water has a lower hardness than the output flow of non-permeate water.

### FIGURES

Embodiments of the present invention are set forth in the following description and are shown in the drawings. Similar numerals refer to similar parts throughout the drawings.

FIG. 1 is a schematic diagram depicting flow of water through a water-softening device constructed and arranged in accordance with an implementation of the invention.

FIG. 2 is a schematic diagram depicting flow of water through a water-softening device constructed and arranged in accordance with an implementation of the invention.

The invention is susceptible to various modifications and alternative forms, and specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as described by the following detailed description and as defined by the appended claims.

### DETAILED DESCRIPTION OF THE INVENTION

The present invention is directed to apparatuses and methods for softening water, in particular to apparatus and methods for softening water without the addition of ions to the wastewater stream.

### A. System Overview

The apparatuses of the invention generally include at least one nanofiltration filter element configured and arranged to receive an input flow of hard water, discharge an output flow of permeate water comprising a first portion of the input flow, and discharge an output flow of non-permeate water comprising a second portion of the input flow. At least a portion of the output flow of permeate water has a lower hardness than the output flow of non-permeate water.

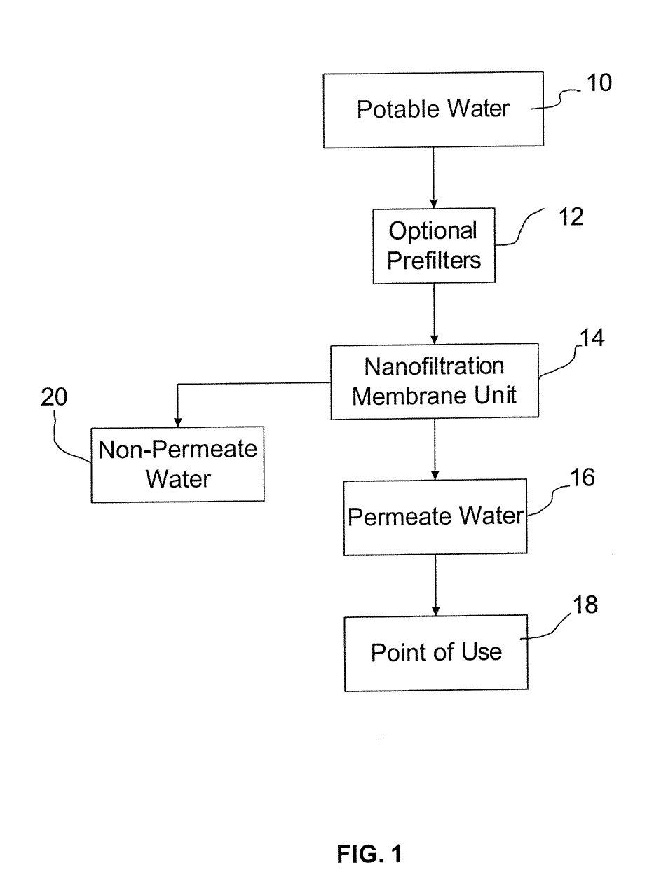

A generalized schematic diagram of a first implementation of the invention is shown in FIG. 1. Potable water 10 is supplied (such as from a residential well) and optionally treated by one or more prefilters 12 (such as sediment, chlorine, iron or biological filters). After any pretreatment steps the water passes into a nanofiltration membrane unit 14. The nanofiltration membrane unit 14 contains at least one nanofiltration element along with an input for the potable water and an output for permeate water that has passed through the filter membrane and an output for non-permeate water that has not passed through the filter membrane. The permeate water 16 comprises softened water that is subsequently discharged to a point of use 18. The non-permeate water 20 comprises water that has not traveled through the nanofiltration membrane, as well as divalent hardness ions. This non-permeate water 20 is subsequently discarded, such as by discharge into a sewer or by use for purposes in which hardness ions are not problematic.

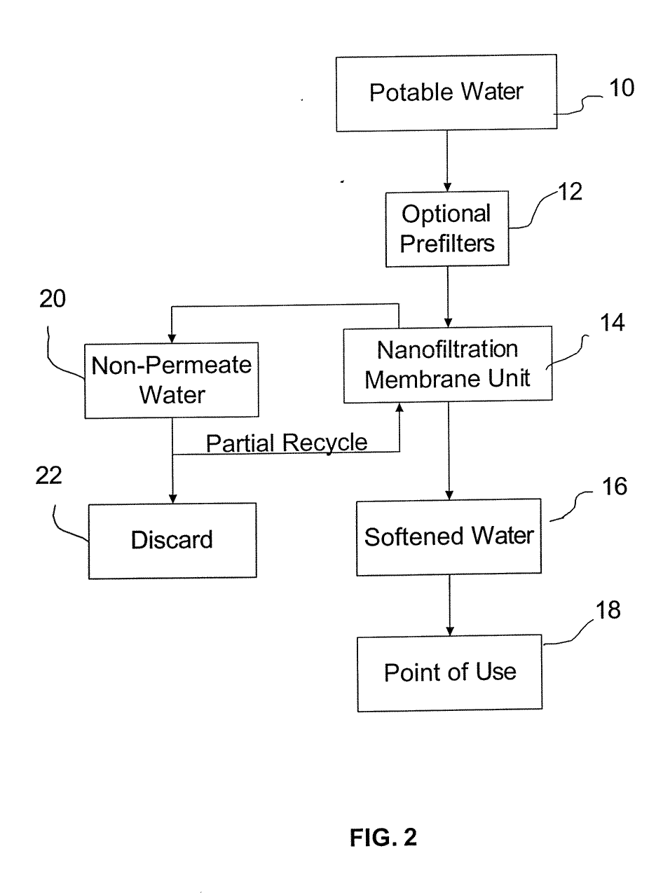

A generalized schematic diagram of a second implementation of the invention is shown in FIG. 2, which is similar to the first implementation except it includes partial recycling of the non-permeate water back through the nanofiltration membrane unit. Potable water 10 is supplied and optionally treated by one or more prefilters 12. After any pretreatment steps the water passes into a nanofiltration membrane unit 14. The nanofiltration membrane unit 14 contains at least one nanofiltration element along with an input for the potable water and an output for permeate water and an output for non-permeate water. The permeate water 16 comprises softened water that is subsequently discharged to a point of use 18. The non-permeate water 20 comprises water that has not traveled through the nanofiltration membrane, as well as divalent hardness ions. A portion of this water 20 can be cycled back into the nanofiltration element unit 14, where additional water can pass through the nanofiltration membrane to increase water recovery. This recycled water can go through the same nanofiltration element that the water originally was passed through, or can go through a second distinct nanofiltration element to increase water recovery. Non-permeate water 20 that is not recycled is discarded in discarded water 22.

In most implementations only one nanofiltration element is used. However, it is also possible to use multiple nanofiltration elements in a parallel arrangement to increase the flow rates, to extend the operating period of the nanofiltration elements, or to permit use of smaller individual elements. Alternatively, it is possible to use multiple nanofiltration elements in series. In such implementations the input water is sequentially sent through two or more nanofiltration elements to provide adequate ion removal and flow rates. Such apparatuses can be advantageous because they permit use of filters having lower ion rejection rates.

The present invention is particularly well suited to installation in existing residences that have a single water distribution network, and thus residences that do not provide different water distribution systems for types of water on the basis of hardness. Water-softening devices are known that produce two water outputs for use in a residence: one with hard water and one with softened water. Such systems require extensive reconfiguration of a user's water supply, and often end up making the hard water (which is used in the system) even harder than the input water. Such systems are disadvantageous because of the difficulty in separating water supplies within a residence, as well as the problem associated with using the water having a higher hardness than the input water. In addition, most implementations of the invention do not require the use of recirculation tanks or holding tanks of partially filtered water, but instead the non-permeate water is discharged to a wastewater stream.

### B. Nanofiltration Element

Various nanofiltration filter elements can be used with the present invention. The filter elements should be suitable for use in softening hard water at relatively low pressures while providing suitably high flow rates and recovery rates. Thus, not all nanofiltration elements provide adequate rejection rates of hardness ions, water flow, and water recovery rates. Suitable nanofiltration elements are described in greater detail below.

In general, the nanofiltration elements suitable for use with the invention have a high rejection rate of divalent ions, along with sufficient flow of water through the nanofiltration elements at relatively low pressures in order to provide a water flow rate and recovery rate that is sufficiently high to meet the needs of most residential customers. These divalent ions include numerous hardness ions, such as calcium and magnesium. By flow rate it is meant the average peak flow rate through the filter. By recovery rate, it is meant the percentage of input water that is recovered as softened water, relative to the amount of water that enters the water softener. Although these specific parameters are all individually important, the combination of these parameters is particularly important in order to provide a water softener that is suitable for use in residences and small businesses.

The nanofiltration filter element typically has an average pore size that permits the passage of water and monovalent ions but substantially rejects the passage of divalent ions, in particular divalent ions associated with water hardness. Although various ions can be used to measure rejection rate, one suitable ion for making such determinations is the calcium ion. Typical nanofiltration filter elements useful with the present invention normally restrict greater than 80 percent of the calcium ions from passing through the filter element under operating conditions. More suitable filter elements restrict greater than 85 percent of the calcium ions from passing through the filter under operating conditions. Even more suitable filter elements have a rejection rate of greater than 90 percent of calcium ions. The nanofiltration elements must have sufficient flow or flux of water. Typically the water flux through the nanofiltration elements is at least 75 liters per square meter of filter membrane per hour (lmh).

Suitable nanofiltration elements typically have a molecular weight filtration cut-off diameter of 20 to 500, even more commonly 100 to 400, and most commonly 200 to 300. As used herein, filtration cut-off (expressed in molecular weight) follows the convention used in filtration measurements, and refers to a range of molecular weights of materials that are excluded at high rates. However, generally small quantities of material will pass through such membranes that have molecular weights within the cut-off range. In addition, relatively high rates of exclusion of molecules outside of the cut-off range can occur, but such exclusion is generally at a lower rate than within the cut-off range. By using a filter with a higher molecular weight cut-off it is possible to increase water flow. In this manner the sufficient exclusion of calcium ions, and adequate water passage, occurs with a filtration element having a molecular weight cut-off range of 200 to 300.

The apparatus is advantageously constructed such that it does not substantially increase the total salt levels relative to the input flow of water. Thus, the softening apparatus does not add ions to the water stream, but rather removes at least some of the ions from the input flow and discharges them into the non-permeate output flow. Various different nanofiltration filter elements are suitable for use with the invention, including filter elements that contain a positively charged membrane, because such membranes generally repel the positive divalent hardness ions and limit there passage through the membrane.

The nanofiltration element dimensions are generally selected based upon the application for which it will be used. Thus, the nanofiltration element's length, width, and surface area can all be selected to improve the softening apparatus' suitability for specific uses. Nanofiltration elements come in various configurations, including spiral wound membranes, hollow tubes, and fibers. In general the nanofiltration element is a spiral wound membrane. The nanofiltration element generally has a surface area of greater than 3 square meters but less than 12 square meters, and more typically from 6 to 10 square meters. The nanofiltration elements should not be so long that they require production of a large housing that will not fit in a residence. In general, the nanofiltration elements are selected such that the softening apparatus will fit in the utility area of a home. Suitable elements can have, for example, a total filter length from 40 to 125 centimeters. Nanofiltration elements suitable for use with the invention typically have a diameter of 5 to 15 cm.

Suitable nanofiltration membranes for use with the water-softening apparatus include Koch Membranes TFC-SR1, a thin film composite polyamide membrane with greater than 99 percent rejection of 0.5 percent MgSO₄ at 95 psig at typically 25 gfd where the feed water has less than 7 to 10 ppm chloride.

### C. Additional Elements

The water softener of the present invention is generally designed to provide high quality water softening on the small scale needed for residential (and similar) applications. The water softener normally provides sufficient water flow such that it is not necessary to have a reservoir or pressure tank containing softened and stored water. Therefore the water softener normally provides adequate instantaneous water softening to meet the needs of a typical household. Avoiding the use of storage tanks is beneficial to consumers because it lessons the likelihood of contamination in the storage tank by microorganisms. In addition, avoiding the use of a holding tank reduces the size and cost of the water softening device. However, in some applications a container for holding at least some softened water to meet peak water demands is used.

Various pre-filters are also suitable for use with the invention in order to improve the performance and longevity of the nanofiltration element. For example, a pre-filter can be used to remove large suspended material that would otherwise clog the nanofiltration filter element. Other pre-filters suitable for use with the invention are iron pre-filters to remove iron from the input water source, sediment pre-filters to remove sediment from the input water source, chlorine pre-filters to remove chlorine from the input water source, and biological pre-filters to remove bacteria, protozoa, and other microorganisms.

In addition to using pre-filters, the water can be pretreated to improve performance by either heating the water sufficiently to improve flow rates without causing scaling, or by magnetically pretreating the input water to inhibit scaling. Other pretreatment steps, such as chemical pretreatment, are suitable for use with implementations of the invention.

### D. Operating Parameters

In general the water softened in the present invention is potable water, such as that provided from a groundwater source. For example, the water can be from a private residential well, from a municipal water supply (typically containing groundwater), or other source. Although the supplied water is usually potable, it is possible to use non-potable water in specific implementations by providing pre-filters that remove contaminants (such as cryptosporidium).

The water softener of the invention is normally sized so that it can be placed in a space equal to or smaller than the space required for a conventional ion-exchange water softener. This allows the softening device to be used as a replacement for existing softeners. In certain implementations the softener of the invention is constructed such that it is significantly smaller than ion exchange softeners of similar softening capacity. Such savings in size are possible because it is not necessary to have ion exchange media or a recharge tank.

As discussed above, water softeners of the present invention are typically constructed and arranged so that they can be operated at relatively low pressures, generally below 250 psig. This low pressure avoids the use of expensive pressurization equipment. Specific embodiments of the invention provide an apparatus configured and arranged to have an output flow of permeate water of 200 gallons or more per 24-hour period. In general the apparatus can have a peak output flow rate of permeate water that is less than 10 gallons per minute, even more generally a peak output flow rate of permeate water that is from 5 to 10 gallons per minute. The softening apparatus is also generally highly efficient, and able to produce an output flow of permeate water containing greater than 80 percent of the input flow. In certain embodiments the output flow of permeate water contains greater than 90 percent of the input flow. The output flow of permeate water generally can have, for example, a hardness below 3.5 grains per gallon.

### E. Methods

The present invention is also directed to methods of softening water. The methods generally include providing at least one nanofiltration filter element configured and arranged to receive an input flow of hard water; receiving an input flow of hard water; discharging a first output flow of permeate water comprising a portion of the input flow and which has passed through the nanofiltration filter; and discharging a second output flow of non-permeate water comprising a portion of the input flow and which has not passed through the nanofiltration filter; wherein the output flow of permeate water has a lower hardness than the output flow of non-permeate water.

Other embodiments of the invention will be apparent to those skilled in the art from consideration of the specification and practice of the invention disclosed herein. It is intended that the specification be considered as exemplary only, with a full scope and spirit of the invention being indicated by the following claims.

1-30. (canceled)

31. A method for softening water, the method comprising:
providing at least one nanofiltration filter element configured reject at least 80 percent of calcium ions:
receiving an input flow of water having at least 2 grains of hardness per gallon;
discharging a first output flow of permeate water comprising at least 80 percent of the input flow, and which has passed through the nanofiltration filter; and
discharging a second output flow of non-permeate water comprising less than 20 percent of the input flow, and which has not passed through the nanofiltration filter;
wherein the output flow of permeate water has a lower hardness than the output flow of non-permeate water.

32. The method for softening water of claim 31, wherein the nanofiltration filter element has an average pore size that substantially permits the passage of water and monovalent ions but substantially prevents the passage of divalent ions.

33. The method for softening water in accordance with claim 31, wherein the method does not substantially increase the total salt levels relative to the input flow of water.

34. The method for softening water in accordance with claim 31, wherein the input flow is provided at a pressure of less than 200 pounds per square inch.

35. The method for softening water in accordance with claim 31, wherein the input flow is provided at a pressure of 140 to 200 pounds per square inch.

36. The method for softening water in accordance with claim 31, wherein the nanofiltration filter element comprises a positively charged membrane.

37. The method for softening water in accordance with claim 31, wherein the output flow of permeate water contains greater than 90 percent of the input flow.

38. The method for softening water in accordance with claim 31, wherein the output flow of permeate water has a hardness below 3.5 grains per gallon.

39. The method for softening water in accordance with claim 31, wherein the method is configured and arranged to have an output stream of permeate water of 200 gallons or more per 24 hour period.

40. Water softened using the method of claim 31.
